(19) United States
(12) Patent Application Publication
(10) Pub. No.: US 2002/0069125 A1
(43) Pub. Date: Jun. 6, 2002

(54) Information transfer between or among commodity businesses

(76) Inventors: Jeremy Alan Bruck, Marietta, GA (US); Dana Eric Hansen, Duluth, GA (US); Hal Bryant Helms, Marietta, GA (US)

Correspondence Address: CHRISTOPHER JOHN RUDY, ATTORNEY AND COUNSELOR, 209 HURON AVENUE, PORT HURON, MI, 48060, US

(21) Appl. No.: 09/865,188

(22) Filed: May 24, 2001

Related U.S. Application Data
(60) Provisional application No. 60/207,769, filed on May 30, 2000.

(51) Int. Cl. G06F 17/60

(52) U.S. Cl. 705/26; 705/37; 705/80

(57) ABSTRACT

A method to transfer information among or between parties for a commodity contract includes: A) providing at least one application service provider (ASP) control site, and at least one adapter at a remote site; B) inputting data about a transaction involving at least one party to the transaction to the ASP control site; C) if necessary, electronically communicating from the ASP control site and through the adapter to the at least one party; C) if necessary, receiving instructions or data at the ASP control site through the adapter from the at least one party; and E) processing the data and/or instructions at the ASP control site. The method can be practiced through a global computer communications network, and is well adapted for agricultural commodity transactions and those conducted through an exchange.

### CROSS-REFERENCE CLAIM OF DOMESTIC PRIORITY

This claims benefit under 35 USC 119(e) of U.S. provisional patent application No. 60/207,769 filed on May 30, 2000 A.D. The complete specification of that application is incorporated herein by reference.

### FIELD OF THE INVENTION

The present invention concerns a method to transfer information among or between parties for commodity transactions, especially agricultural commodity businesses or parties. In particular, electronic message and control is employed to advantage, especially by way of the well known global computer communications network (also known as the Internet system).

### BACKGROUND TO THE INVENTION

In general, the agriculture industry, as an example as well as a type of commodity marketplace, is facing numerous challenges in a rapidly changing, electronically driven economy. The historical commodity-driven marketplace is evolving into a consumer-needs-driven economy. The impact of the Internet system is accelerating this transformation. One of the greatest challenges facing the industry is a redefining of the distributor and retail role in the industry versus the traditional logistic business model. These demands are being put on a non-integrated agriculture supply chain that is highly fragmented. The industry has been experiencing consolidation and vertical integration to meet the needs of the changing environment, but the fear of a non-competitive marketplace through excessive government control has slowed this movement down. The Internet system has brought numerous exchanges or marketplaces to the agriculture sector. All of these factors, coupled with a short supply of quality workforce, have put the industry in a state of flux.

Agricultural commodity transactions as they are known to exist today between buyers and sellers have been carried out by a buyer and seller agreeing to a contract for a set amount of a commodity, say, corn, at a certain volume, grade, and so forth through the auspices of an exchange or other negotiation methods. Once the contract was made, the exchange or the negotiation parties provide the buyer and seller with salient information, and the buyer and seller were separately on their own under the contract. Communication between the buyer and seller has been by voice, courier service, mail, telephone, fax or electronic mail. Occasional errors owing to communication between the buyer and seller concerning the time of execution of the contract and delivery of the goods, pricing information, and failure of a buyer's or seller's system with consequent loss of contract information would occur.

It is desired to ameliorate or solve such problems as stated, and improve upon the aforementioned method of operating.

### SUMMARY OF THE INVENTION

The present invention provides a method to transfer information among or between parties for a commodity contract, which is comprised of the following:

providing at least one application service provider (ASP) control site, and at least one adapter at a remote site;

inputting information (data) about a transaction involving at least one party to the transaction to the ASP control site;

if necessary, electronically communicating from the ASP control site and through the adapter to the at least one party;

if necessary, receiving instructions or data at the ASP control site through the adapter from the at least one party; and

processing the data and/or instructions at the ASP control site.

The invention is useful in information exchange, particularly with respect to commodities contracts, especially as they pertain to agricultural commodities.

Significantly, by the invention, commodities transactions, and most especially agricultural commodities transactions through participating commodities exchanges, are dramatically streamlined. In particular, for the first time, agricultural commodities transactions can be controlled and/or monitored at an ASP control site electronically, for example, through the global computer communications network, automatically. Thus, such transactions can be standardized as well as tailored to suit the participating party, and problems such as the chance of error from faulty communications between participants as well as and the chance of loss of data are ameliorated if not completely overcome. The invention is highly efficient.

Numerous further advantages attend the invention.

### DRAWINGS IN BRIEF

The drawings form part of the specification hereof. With respect to the drawings, the following is briefly noted:

FIG. 1 is a diagram of a basic workflow overview in the practice of the invention.

FIG. 2 is a diagram of workflow from an exchange in the practice of the invention.

FIG. 3 is a diagram of workflow for business-to-business in the practice of the invention.

FIG. 4 is a diagram of direct business-to-business workflow in the practice of the invention.

FIG. 5 is a diagram of direct business-to-business workflow with direct adapter-to-adapter communication in the practice of the invention.

FIG. 6 is a diagram of an embodiment of the invention as practiced over the Internet system.

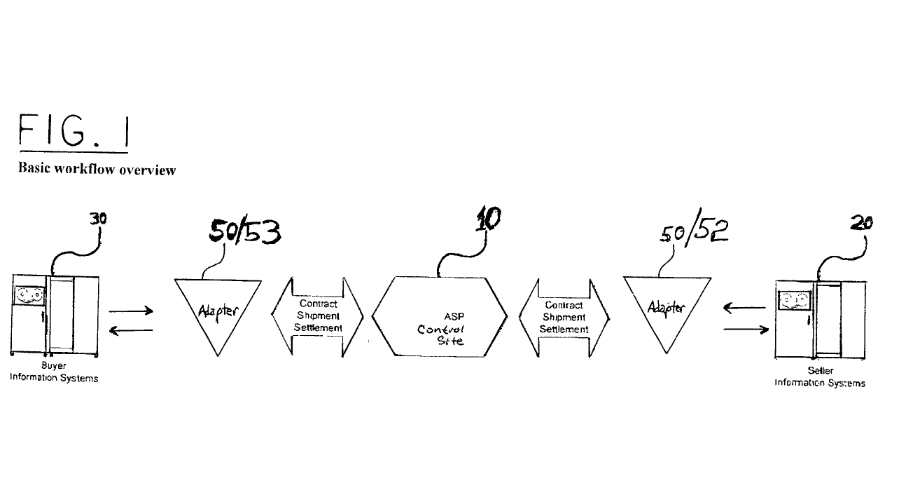

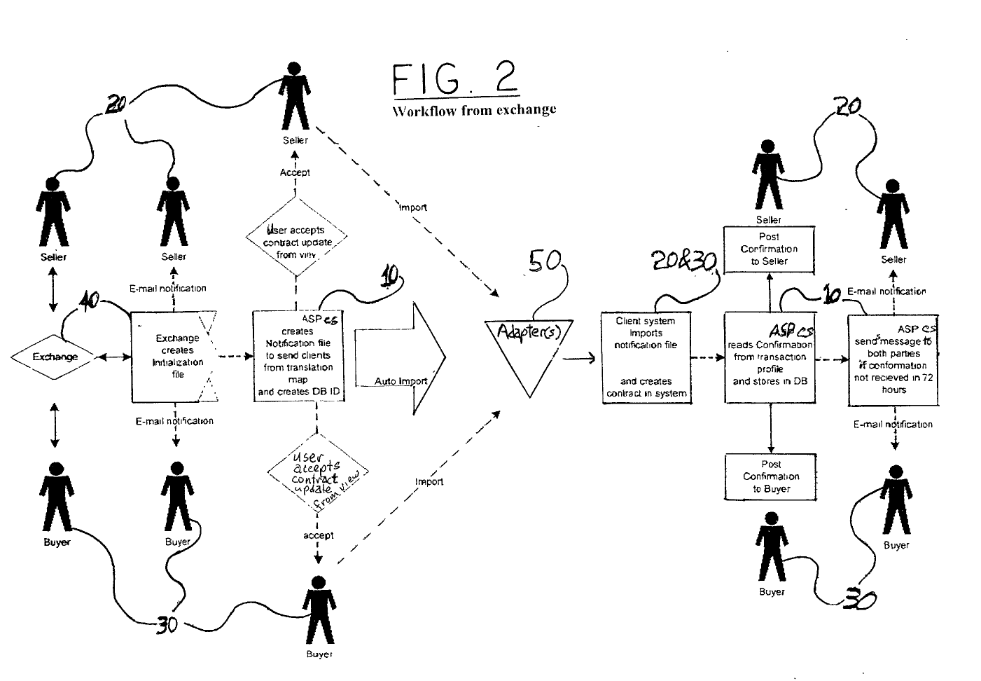

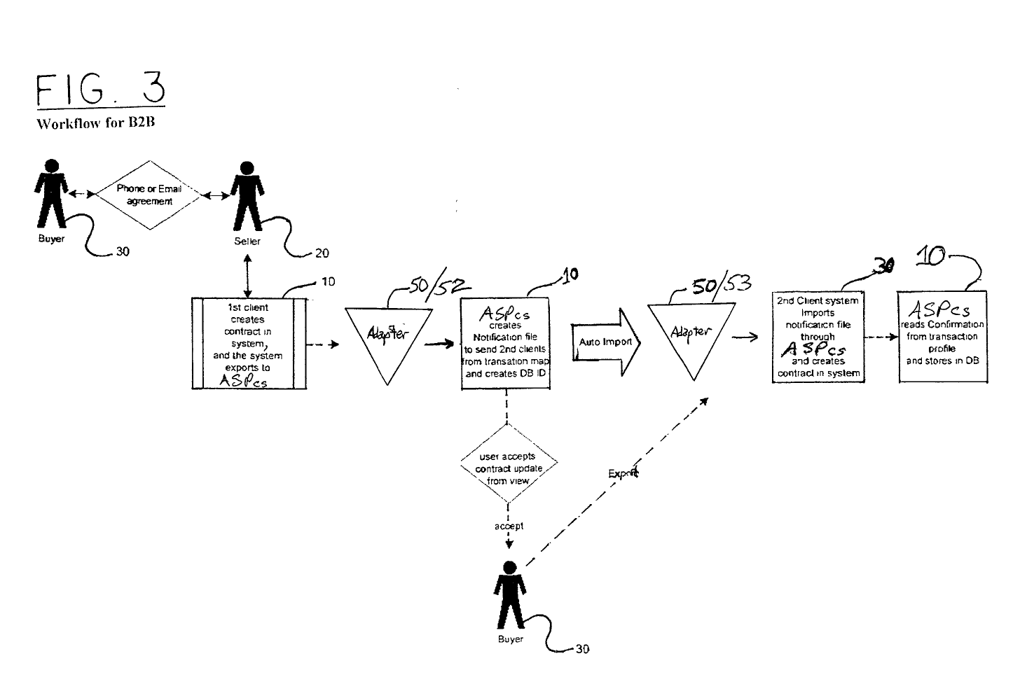

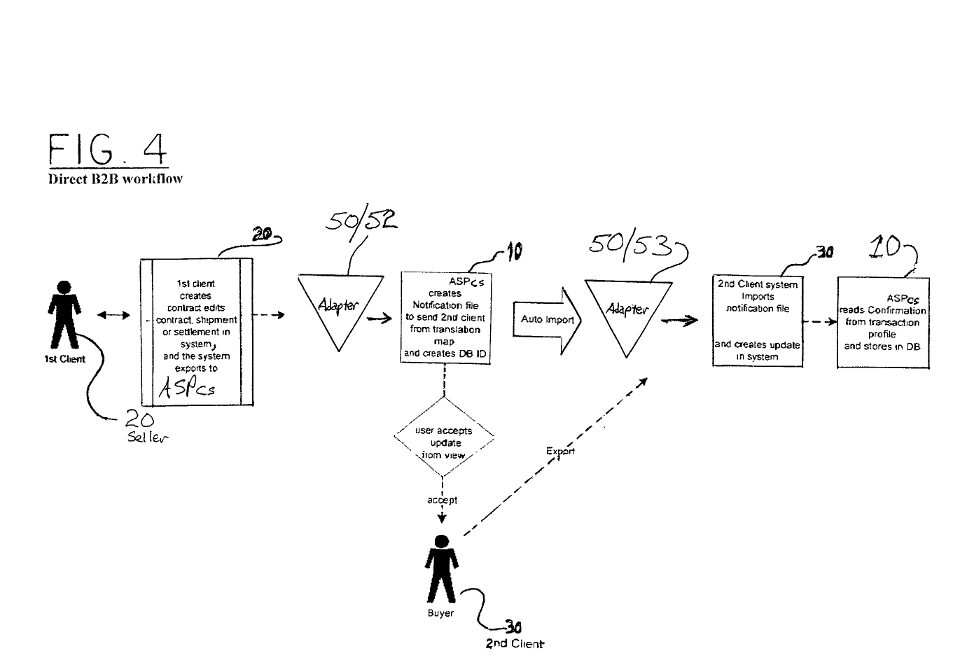

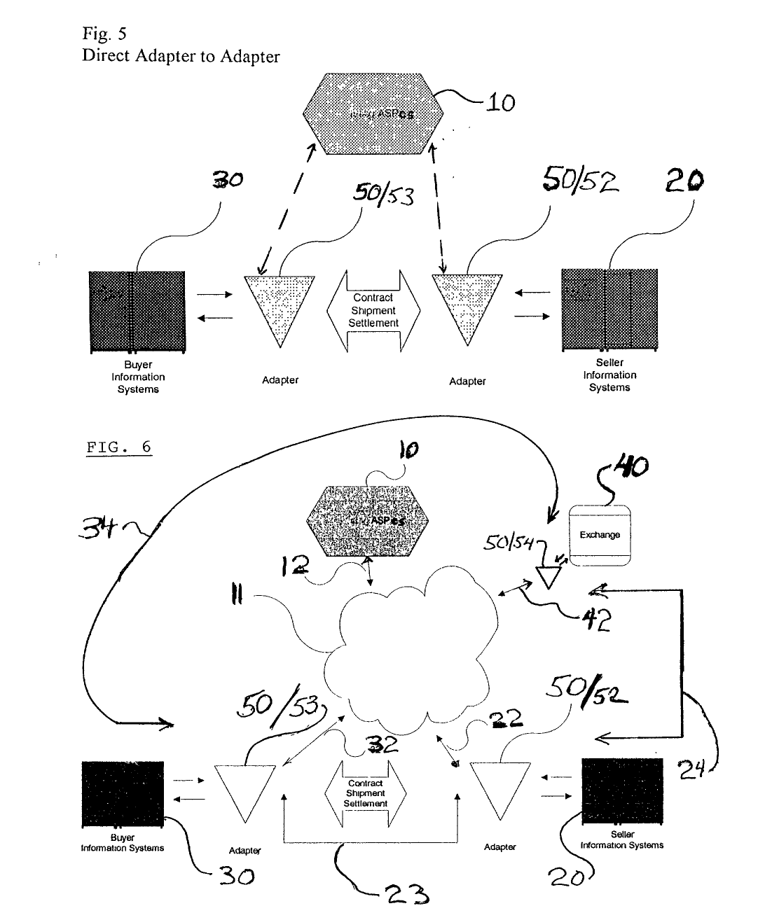

### ILLUSTRATIVE DETAIL OF THE INVENTION

The invention can be further understood by the present detail, which may be read in view of the drawings. Such is to be taken in an illustrative and not necessarily limiting sense.

In general, the invention provides a method to transfer information among or between parties to a commodity contract. Preferably, the commodities are agricultural commodities.

In the method, at least one ASP control site such as an available processing and messaging unit is provided. An ASP control site may be thought of as a “hub.” In a typical, simple arrangement, one ASP control site is present. In any case, for example, the ASP control site processing and messaging unit can be an electronic computer run with suitable software, to include so-called IBM-compatible, Mac-compatible, and other computer and portable stations equipped with MS-DOS, OS/2, Windows-3.1, Windows-95, Windows-98, and Windows-2000, Linux, NT, Sun, Unix, enhanced versions thereof, and so forth operating systems.

As well, at least one adapter is provided at a site remote from the ASP control site, typically at the user location. Often a plurality of adapters are provided, say, one each per remote site. At the remote site is a client served by the hub, who may become a party to the commodity transaction. The remote site may be thought of as a “spoke.” In general, the adapter is a small database and software application that resides on the server (hardware) of a client, which may be any suitable hardware having any suitable operating system such as mentioned previously. The adapter acts as an interface between the information systems (IS) with commodity accounting system (CAS), which is also known as a “back end system,” of a client, and the ASP control site. The adapter notes changes in the CAS of the client party and, if required, forwards the changes to the ASP control site. It also receives notifications from the ASP control site and updates the IS/CAS of the client party with those changes. The adapters, which may be termed, “system adapters” or “connectors,” typically have formatting and encryption capability, database, and function, encrypting and translating data as may be necessary. Herein, translating primarily is concerned with programming and data language activities. It also may refer to conversion of one unit of measure to another or one language to another. However, in general, the adapter may be considered as an intermediary between or among client(s) and/or the ASP control site to which it(they) is(are) in communication. The adapter may be provided by any suitable method such as by downloading it through the Internet system; delivering a disc with the necessary adapter material through the mail or by courier, to be loaded on the hardware of the client; or sending programming personnel to the remote site to program the adapter into the hardware of the client. The client can be an exchange, a buyer and/or a seller, each of whom may become what is generally termed, a “party,” in the practice of the invention when an agreement or contract is sought or entered into. The buyer and seller, for example, may become, more strictly speaking, “parties,” to a contract itself, as understood in commercial legal parlance.

Further, information about a transaction is input into the system and received at the ASP control site. The information details may be entered by any suitable manner such as manually and/or electronically. For the most part, data is entered initially manually at least once, say, in a back office system of a client; however, initial electronic input can occur, say, by the transmission of the weight of a truck loaded with the commodity which passes across electronic scales. Electronic input of information into the system, nonetheless, can occur in the method later on, as may manual input. These details can concern a transaction involving one party or a plurality of parties to the transaction, and many parties may be involved in a transaction or series of transactions. For example, the information can be input from a commodities exchange site or a business having the adapter with translation database link in suitable communication with the the ASP control site through the adapter, say, through the Internet system. The ASP control site may monitor the client(s) or party(ies) as a primary function in a business-to-business (a spoke-to-spoke) transaction, and this monitoring may be considered to be within the ambit of this part.

Also, electronic communication from the ASP control site and through the adapter to one client or party or to more than one client or party is generally involved, if necessary. This is concerned primarily with a transaction through the hub. In a business-to-business transaction, it may be considered that such communication is not occurring. However, the ASP control site may monitor the client(s) or party(ies). An electronic communication to a client may can pass generally through or under the form of a notification file or notification method from the ASP control site to the party or parties. The notification may be by any suitable method such as by generation of electronic mail or alert, facsimile, phone call and so forth, which serves to permit the client to react thereto.

Further, instructions from the party or parties to the transaction are transmitted to and received by the ASP control site, if necessary. These instructions, again, pass through the adapter(s). When a spoke-to-spoke model is in operation, such instruction may be considered to be implied when the ASP control site hub is merely monitoring, or such may be absent.

Furthermore, processing the instructions or data is involved. This may be conducted at the ASP control site and/or the adapter at the site of the client or party to the system and transaction. This processing can engender a further round of communication and/or the simple provision of a file.

Added processing, which may be considered step(s) also, such as post-processing monitoring and/or communication to the party or the parties may be carried out in practice of the invention. These can employ the ASP control site and adapter(s).

Although any suitable means of electronic communication may be employed, preferably in the practice of the invention the electronic communication is by way of the Internet system. Yet, the electronic communication may be carried out, for instance, through an intranet or an extranet network, and so forth.

Although only one party is required to be electronically in communication, on occasion or from time to time, with the ASP control site, a plurality of parties are frequently involved. For example, there can be under consideration two parties, a buyer and a seller, as well as perhaps a commodities exchange, each of whom has a site having the adapter with translation database linked with the ASP control site. Many, many transactions, say, into the thousands or millions, can be controlled and/or monitored by the ASP control site in the practice of the invention.

Thus, one ASP control site hub may have many spokes. Also, one ASP control site hub may communicate with another ASP control site (hub-to-hub communication) in the practice of the invention.

In preferred embodiments of the invention such as practiced in the agricultural commodities business by lstAg, Inc., the invention can be considered to be a method of automatically transferring information among or between agricultural commodity parties or businesses. In general, three exemplary and instructive aspects are extant:

1) The ASP control site is a connection for parties involved in an agricultural commodities exchange-mediated transaction. Contract information from an exchange site—the exchange being one at which two parties have agreed to a contract for buying and selling an agricultural commodity, say, corn—is sent to the ASP control site; the information is then formatted at the ASP control site, and sent with encryption to each of the parties involved with the contract for the corn. The parties allow the system adapter with translation database to automatically update their back office systems with the contract-related information, with the option of verification of such information. This is a typical hub-to-spoke operation.

2) The ASP control site becomes a connection between business-to-business commodity transactions. Here, the contract, contract amendment, shipment and settlement information is transferred from one company's business systems through the related ASP control site; exported from the ASP control site through the connector, with encryption; and imported into the second party's business systems having the system adapter with translation database and encryption, for decryption and report. This represents another typical hub-to-spoke operation.

3) The ASP control site becomes a reference between business-to-business commodity transactions, i.e., it lstAg-493 10 serves generally as a monitor for the operation. Here, the contract, contract amendment, shipment and settlement information is transferred from one company's business system through the system adapters with encryption, and imported into the second party's business system with the adapter with translation database and encryption, for decryption and report. This represents a typical spoke-to-spoke (peer-to-peer) operation.

All such aspects of these preferred embodiments of the invention reduce the time and labor cost to enter information into each system, and reduce the chance for errors. As well, the ASP control site keeps a record of the information, and serves as a backup should a party's system lose data. As a general rule, features or parts of the preferred system of the invention can include the following:

A) Download of system information from an exchange or a business to the ASP control site, say, through the Internet.

B) Matching up data from the system information to ASP control site cross-reference tables so that the same information can be tailored to, or, as it were, translated for, a particular client party. For example, that which the exchange may term, “corn,” it being of a certain grade; the selling party may term, “#2 corn,” with the buying party terming it, “yellow corn.” of course, other matters may be cross-referenced for the parties or clients, including weights, grades, and discount standards, say, “pounds” vs. “lbs.,” and language standards.

C) ASP control site two-way communication to the business system sites of member parties or clients.

D) ASP control site allowing the customer to verify updates according to an “accept/reject” format, or according to a preselected, automatic “Yes” update.

E) System adapter with translation database that decrypt and populate data tables for back office integration.

F) ASP control site confirmation of updated records sent to each participating client system.

G) ASP control site allowing the user to view and print reports of their activity through the system, say again, over the Internet.

The invention allows contract, contract amendment, shipment and settlement information to be exchanged among or between clients' business systems; it provides a protocol for software applications to communicate via the Internet. The invention can allow the contract from the exchange to update the party's (client's) business system, and allow companies with different business systems to communicate transactions among or between them.

With particular respect to the drawings, ASP control site 10, staffed, for example, by a commercially available computer system running customized and purchased software, is the heart of the system. Seller 20 and/or buyer 30, who may interact through an agricultural commodity exchange 40, come to terms with respect to the raw, processed and/or finished agricultural commodity and so forth in a contract. Thus, at least one party as mentioned hereinbefore can be either a buyer and a seller, or both a buyer and a seller. Alternatively, more than one buyer and/or more than one seller may participate in the practice of the invention. Adapter 50 is provided at the remote client (buyer and/or seller) site. Information about the terms of the contract including the commodity under agreement is electronically communicated from the commodity exchange site 40 to the control site 10. The control site 10 sends a notification to each client, for example, both the seller 20 and the buyer 30 through the adapters 50. The buyer 20 and seller 30 are identified on the control site 10 by identification data, and any preference or desire as to various parameters and nomenclature is entered into the ASP control site 10 so as to provide data for a cross-reference map, tailored to each client. Updates in the information such as commodities, units of measure, dates, prices, weights, grades, and discount standards are entered into the control site 10 by the exchange 40 and/or negotiating parties. Updates may be provided for consideration at any suitable time, for example, with real time or batch processing. Also, data of a client 20, 30 may be electronically verified after sending him data, say, at five- or ten-minute intervals, to ascertain as to whether or not he has received the update. This may be carried out, for example, by reading a confirmation table or message electronically, or by any other suitable format. Advantageously and beneficially, the electronic communication is conducted over the Internet system 11, with the control site 10 having Internet system line of communication 12, the seller 20 having Internet system line of communication 22, the buyer 30 having Internet system line of communication 32, and the commodities exchange 40 having Internet system line of communication 42. The commodity information transmitted to and from the buyer 20 and/or seller 30 passes, in general, through the adapter 50. There may be direct lines of communication between participants as well, for example, with seller-to-buyer direct line 23, seller-to-exchange direct line 24, and buyer-to-exchange direct line 34, each of which direct lines passing through a network, say, the Internet system 11. Other direct line systems (not illustrated) may be employed. The adapter or connector 50 may be installed at a remote location for a seller, thus particularly being seller system adapter 52; for a buyer, thus particularly being buyer system adapter 53; or for an exchange, thus particularly being exchange system adapter 54.

Billing may be sent to the client with the commodity information. Preferably, however, billings are sent separately from the commodity information. Any suitable manner of sending the billing may be employed to include over the Internet or other net, by the mails, by phone or fax, and so forth and the like. Likewise, payment from the client can be transmitted in any suitable method to include over the Internet or other net, by the mails, by credit card authorization by phone or fax, by electronic fund transfer, and so forth and the like.

Accordingly, the invention receives justifiable praise. As well, it meets with commercial success.

### Conclusion

The present invention is thus provided. Various features, parts, subcombinations and combinations of the invention can be employed with or without reference to other features, parts, subcombinations or combinations in the practice of the invention, and numerous adaptations and modifications can be effected within its spirit, the literal claim scope of which is particularly pointed out as follows:

We claim:

1. A method to transfer information among or between parties for a commodity contract, which is comprised of the following:
providing at least one application service provider (ASP) control site, and at least one adapter at a remote site;
inputting information (data) about a transaction involving at least one party to the transaction to the ASP control site;
if necessary, electronically communicating from the ASP control site and through the adapter to the at least one party;
if necessary, receiving instructions or data at the ASP control site through the adapter from the at least one party; and
processing the data and/or instructions at the ASP control site.

2. The method of claim 1, wherein information is transmitted from a commodity exchange.

3. The method of claim 1, wherein electronic communication through a global computer communications system is employed.

4. The method of claim 1, wherein business-to-business information is exchanged.

5. The method of claim 4, which employs direct business-to-business workflow.

6. The method of claim 5, wherein the direct business-to-business workflow employs adapter-to-adapter communication.

7. The method of claim 4, wherein electronic communication through a global computer communications system is employed.

8. A method to transfer information among or between parties for an agricultural commodity contract, which is comprised of the following:
providing at least one application service provider (ASP) control site, and at least one adapter at a remote site;
inputting information (data) about a transaction involving at least one party to the transaction to the ASP control site;
if necessary, electronically communicating from the ASP control site and through the adapter to the at least one party;
if necessary, receiving instructions or data at the ASP control site through the adapter from the at least one party; and
processing the data and/or instructions at the ASP control site.

9. The method of claim 8, wherein information is transmitted from an agricultural commodity exchange.

10. The method of claim 9, wherein electronic communication through a global computer communications system is employed.

11. The method of claim 8, wherein business-to-business information is exchanged.

12. The method of claim 9, wherein business-to-business information is exchanged.

13. The method of claim 11, wherein business-to-business information is exchanged employing direct business-to-business workflow.

14. The method of claim 13, wherein the direct business-to-business workflow employs adapter-to-adapter communication.

15. The method of claim 8, wherein electronic communication through a global computer communications system is employed.

16. The method of claim 12, wherein electronic communication through a global computer communications system is employed.

17. The method of claim 14, wherein electronic communication through a global computer communications system is employed.

18. A method to transfer information among or between parties for a commodity contract, which method comprises:
providing at least one application service provider (ASP) control site, and at least one adapter at a remote site;
inputting information about a transaction involving at least one party to the transaction to the ASP control site;
electronically communicating from the ASP control site and through the adapter to the at least one party;
receiving instructions or data at the ASP control site through the adapter from the at least one party; and
processing the instructions at the ASP control site.

19. The method of claim 18, wherein electronic communication through a global computer communications system is employed.

20. The method of claim 19, wherein the commodity is agricultural, and the contract is obtained through an exchange.
